(19) United States
(12) Patent Application Publication
(10) Pub. No.: US 2026/0346347 A1
(43) Pub. Date: Nov. 5, 2026

(54) METHOD FOR THE CHIPPING PRODUCTION OF A CONCAVE CONTOUR, MILLING MACHINE

(71) Applicant: Siemens Aktiengesellschaft, München (DE)

(72) Inventor: Klaus Rahn, Erlangen (DE)

(21) Appl. No.: 19/485,866

(22) PCT Filed: May 8, 2024
(86) PCT No.: PCT/EP2024/062687

§ 371 Date: Nov. 19, 2025

(30) Foreign Application Priority Data
May 22, 2023 (EP) 23174572

(51) Int. Cl. B23C 3/02; B23C 5/10

(52) U.S. Cl. CPC B23C 3/02; B23C 5/10; B23C 2220/04; B23C 2220/32; B23C 2220/52

(57) ABSTRACT

A method is provided for the chipping production of a concave contour in a workpiece by a milling cutter of a milling machine. The milling cutter is rotatable about a tool axis, wherein the milling cutter is guided along a movement path during the machining operation such that one or more blades of the milling cutter remove material of the workpiece, resulting in the contour. In order to accelerate the manufacture of concave contours, the tool axis of the milling cutter is inclined with respect to the movement path such that the milling cutter removes material from the workpiece only using the blades that are situated at the front in a current movement direction along the movement path, and the blades that are situated at the back in a current movement direction along the movement path do not perform any material removal from the workpiece.

The present patent document is a § 371 nationalization of PCT Application Serial No. PCT/EP2024/062687, filed May 8, 2024, designating the United States, and this patent document also claims the benefit of European Patent Application No. 23174572, filed May 22, 2023, which are incorporated by reference in their entireties.

### TECHNICAL FIELD

The disclosure relates to a method for the chipping production of a concave contour, (e.g., a pocket or circular pocket), in a workpiece by a milling cutter of a milling machine, wherein the milling cutter is rotatable around a tool axis, and wherein the rotating milling cutter is guided along a movement path during the machining operation such that one or more blades of the milling cutter remove material of the workpiece so that the contour results.

### BACKGROUND

In the field of chipping machining, a pocket is a cavity introduced by milling into a workpiece. It may be milled using a milling cutter in a special shape to create a specific pocket shape. The pocket may be used to insert specific parts or components into the workpiece or to cut out a specific point. Pockets may be milled in various sizes and depths and may require special milling tools and machining strategies.

A circular pocket is a special type of recess or cavity in a workpiece which is worked into a workpiece by a circular milling operation. The circular pocket may also be used as a starting point for further machining, (e.g., for milling threads or holes), and may be milled in various sizes and depths.

A machine-tool is a machine that brings workpieces into specific shapes and sizes by machining materials such as metal, wood, or plastic. The most important representatives include turning and milling machines, eroding machines, and mechanical presses and power hammers for forging. The disclosure relates to methods that are applied by milling machines.

A contour describes the outer shape of an object or a surface. The contour of the pocket is the geometry of the interface between the material of the workpiece and the surrounding medium, e.g., air.

The production of circular pockets in workpieces presently takes place very slowly. A first option provides a pilot hole, so that a further tool with a tool change is necessary.

Alternatively, or additionally, the circular pocket may be created using a slow 3-axis helical movement, wherein the milling cutter also remains engaged and “post cuts” with the rear part in the direction of movement due to the axial feed of the helical movement. This post cutting has the result that the feed has to be set very slow.

Both production strategies and mixed forms thereof are time-consuming due to additional tool changes and/or obligatorily slow production methods.

Conventionally, there is no faster solution for producing concave contours, in particular circular pockets in workpieces.

Milling a linear movement path is known from EP 0 264 673 A1, wherein the tool axis of the milling cutter is inclined in relation to the movement direction during the movement along the straight movement path.

Applying a spiral-shaped movement path for the end-milling creation of recesses by a specially designed milling tool is known from U.S. Patent Application Publication No. 2012/0207869 A1.

Milling a curved, cavity-like recess having circular cross section by a side milling cutter is known from EP 2 586 551 A1.

### SUMMARY AND DESCRIPTION

The scope of the present disclosure is defined solely by the appended claims and is not affected to any degree by the statements within this summary. The present embodiments may obviate one or more of the drawbacks or limitations in the related art.

Proceeding from the described problems and disadvantages of the prior art, the disclosure has the object of refining a method of the type defined at the outset so that the explained problems and disadvantages are avoided. In particular, it is the object of the disclosure to provide a faster method for producing concave contours, pockets, and in particular circular pockets.

In certain examples, the method of the type mentioned at the outset is proposed. In the method, the tool axis of the milling cutter is inclined in relation to the movement path such that the milling cutter only removes material from the workpiece using the blades located in front in the present movement direction along the movement path and the blades respectively located at the rear in the present movement direction along the movement path do not perform material removal from the workpiece.

In certain examples, the movement path includes curved sections (as shown in FIG. 1, for example). The movement path may be three-dimensionally curved in this case (as shown in FIG. 1, for example), so that it is possible to mill out pockets, in particular along a helix-type movement path of the milling cutter or along a helical movement path of the milling cutter, in particular along a circular helix.

In this case, a permanent adjustment of the inclination of the tool axis may take place during the movement along the curved sections of the movement path. This permanent adjustment is necessary if a curved movement path of the milling cutter is provided for producing a concave contour, for example, for the purpose of milling a pocket, while simultaneously fulfilling the requirement that the tool axis of the milling cutter is inclined in relation to the movement path such that the milling cutter only removes material from the workpiece using the blades located in front in the current movement direction along the movement path and the blades respectively located at the rear in the present movement direction along the movement path do not perform material removal from the workpiece. The curvature of the movement path may be a curvature that is steady at least in some sections, in particular a three-dimensional curvature that is steady in some sections. Curved sections of the movement path are understood to mean that the milling cutter moves during a period of time and along a route along the curved section of the movement path during the production. In contrast thereto, it is not a merely punctiform curvature or corner of the movement path. The inclination of the tool axis is permanently necessary in this phase of traveling through such a curved section in order to meet the requirements for the alignment of the tool axis, so that the undesired post-cutting does not take place.

Due to the forward inclination of the milling cutter, a collision occurs between milling cutter and pocket upper edge in pockets from a specific depth during conventional production. The disclosure therefore provides that the milling cutter is also inclined in the direction of a center axis extending in the depth direction in the depression or pocket or especially in a circular pocket, in order to avoid such a collision. In a circular pocket, this center axis may also be referred to as the circular pocket axis or as the circular pocket depth axis. This direction of the inclination continuously changes during the production as a result of the movement of the milling cutter along a movement path extending in the circumferential direction. In this way, a dynamic adjustment, or also tracking, of the inclination of the milling cutter takes place. In this way, the milling cutter does not collide with the upper edge of the pocket in particular.

In certain examples, upon reaching the target depth, the milling cutter stands up, so that the bottom of the pocket may be machined or is machined to the desired geometry. In particular, the bottom of the pocket may be face milled, in particular by circular movements during the milling. In certain examples, a bottom that is crowned due to the inclined setting of the milling cutter axis may be leveled out.

It is particularly expediently provided for this purpose that the tool axis is inclined forward around a leading angle in the movement direction at least enough that a frontal center end face of the milling cutter is at least parallel to a tangent on the movement path, so that the blades of the milling cutter located at the rear in the movement direction do not cut or post-cut as a result of the axial feed in the depth direction of the contour. The leading angle may be selected as somewhat larger, so that the blades located at the rear do not have removing material contact with a high level of certainty.

To prevent a collision of the milling cutter with the side walls of the contour as a result of the leading angle, the tool axis is inclined in the direction of a surface normal of the concave contour to be produced at the contact point of the milling cutter on the material. In this way, the milling cutter evades the already machined side wall of the contour with its area closer to the toolholder.

Expressed in simplified terms, for easier spatial conception, the milling machine moves the tool in the concave recess comparably to a cook, who stirs the contents of a bowl (concave contour) from the wrist (inclination of the spoon handle toward the center of the bowl) using a spoon (tool is the spoon, spoon handle is the tool axis) and in this case the spoon is held inclined such that the handle constantly leads the spoon somewhat. The tool thus only cuts using the desired part of the milling cutter, which is in front viewed in the movement direction, and it is possible to work with a high rate of feed. The concave contour is therefore produced in a shorter time than usual. With a 5-axis machine, the movement of the milling cutter is represented differently to the spatially fixed observer, because the movement of the tool is partially implemented by a rotating and pivoting movement of the machine table and partially by the translation of the tool spindle.

As disclosed herein, a milling cutter is a tool used for cutting materials such as metal, plastic, or wood. The milling cutter includes a rotating blade or of blades that may be mounted on a rotating spindle. The milling cutter is used in a milling machine, which holds the workpiece and controls the movement of the milling cutter. The shaft cutter has a cylindrical or conical shape and may be used in a milling machine. The shaft of the milling cutter is shaped so that it may be chucked in the collet or by the chuck of the machine. There are various types of shaft cutters, including end cutters, face cutters, grooving cutters, and ball cutters, which may be used for various types of milling work.

In certain examples, the blades located in front in the movement direction along the movement path are the blades which are located in a peripheral direction of the milling cutter with respect to the tool axis in an angle range up to 90° in absolute value in each case in relation to the movement direction along the movement path and the blades located at the rear are those which enclose an angle of greater than 90° in absolute value with the movement direction along the movement path.

In certain examples, during the material-removing production process of the milling machine, a present contact point of the milling cutter on the material of the concave contour to be produced defines the zero point of a perpendicular spatial coordinate system, wherein a surface normal of the concave contour to be produced at the contact point of the milling cutter on the material defines a first axis of the coordinate system, wherein a tangent on the movement path at the contact point defines a second axis of the coordinate system and a third axis of the coordinate system is arranged perpendicular to the first axis and second axis, wherein the tool axis is inclined in relation to the movement path such that an angle less than 90° is formed between a projection of the tool axis in the plane of a planar coordinate system of the second axis and third axis in the first quadrant of the planar coordinate system in relation to the second axis, wherein the tool axis is inclined in relation to the first axis such that an angle less than 90° forms between a projection of the tool axis in the plane of a planar coordinate system of the first and third axis in the first quadrant of this planar coordinate system in relation to the first axis.

In certain examples, the contour has circular-cylindrical side walls and the movement path is a helix. The tool axis is inclined forward in the movement direction. At the same time, the tool axis is inclined in the direction of the circular pocket center.

In certain examples, to produce a contour having a planar bottom surface and side walls perpendicular to the bottom surface, wherein the milling cutter is a cylindrical shaft cutter, wherein a first movement phase provides machining as claimed in any one of the preceding claims, wherein a second movement phase provides an alignment of the tool axis in the area of the planar bottom surface to be produced perpendicular to the bottom surface and milling of the side walls by lateral cutting of the shaft cutter, and wherein a third movement phase provides planar milling of the planar bottom surface by an end face of the shaft cutter.

The milling machine prepared to carry out the method is particularly advantageously designed as a 5-axis milling machine. It is expedient in this case if three translational movement axes of a toolholder, one pivot axis of a machine table, and one rotational axis of the machine table are provided.

In principle, the method may be carried out, for example, by a shaft cutter, a toric cutter, a ball cutter, or a barrel cutter. The milling cutter may be a cylindrical shaft cutter.

### BRIEF DESCRIPTION OF THE DRAWINGS

Further features, properties, and advantages of the present disclosure result from the following description with reference to the appended figures.

FIG. 1 depicts an example of a schematic three-dimensional representation of a milling machine having a workpiece during the performance of the method.

FIG. 2 depicts a flow chart that illustrates acts of an example of a method.

### DETAILED DESCRIPTION

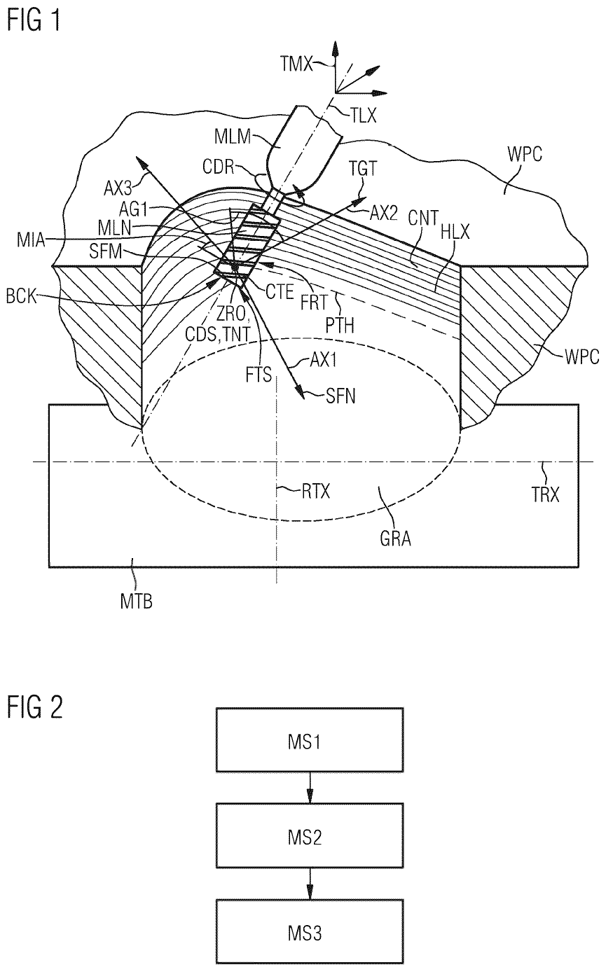

FIG. 1 shows by way of example a milling machine MLM during the performance of a method for the chipping production of a concave contour CNT in a workpiece WPC by a milling cutter MLN, which is fastened in a toolholder TRC of the milling machine MLM. The contour may have a cross-section varying arbitrarily over the contour depth in this case, as long as the contour remains concave. Planar surfaces as part of the contour are also possible in this case. In particular, it may be a pocket having constant cross-sectional profile in the depth direction, for example, a circular pocket.

The milling machine MLM is a 5-axis milling machine MLM here having three translational movement axes TMX of the toolholder TRC, having a pivot axis TRX of a machine table MTB, and a rotation axis RTX of the machine table MTB. The workpiece WPC is attached or chucked in a manner not shown in greater detail on the machine table MTB. The milling cutter MLN is a cylindrical shaft cutter SFM.

The milling cutter MLN is rotatable around a tool axis TLX and is guided rotating during the machining operation along a movement path PTH. The movement path PTH is designed in this case such that one or more blades CTE of the milling cutter MLN remove material of the workpiece WPC, so that the contour CNT results.

As described herein, the tool axis TLX of the milling cutter MLN is inclined in relation to the movement path PTH such that the milling cutter MLN only removes material from the workpiece WPC using the blades CTE located in front FRT in the current movement direction along the movement path PTH and the blades CTE located at the rear BCK in each case in the current movement direction along the movement path PTH do not perform material removal from the workpiece WPC. In this case, blades CTE located “in front” mean the blades CTE that are each in an angle range up to 90° in absolute value in relation to the movement direction along the movement path PTH in a peripheral direction CDR of the milling cutter MLN with respect to the tool axis TLX. Accordingly, the other blades CTE located at the rear BCK are those which enclose an angle of greater than 90° in absolute value with the movement direction along the movement path PTH.

For a somewhat more precise way of observing the three-dimensional inclination of the milling cutter according to the method, it is expedient to observe a coordinate system which follows the movement path PTH.

A current contact point TPT of the milling cutter MLN on the material of the concave contour CNT to be produced is the zero point ZRO of a perpendicular three-dimensional coordinate system CDS. A surface normal SFN of the concave contour CNT to be produced at the contact point TPT of the milling cutter MLN on the material is a first axis AX1 of the coordinate system CDS. A tangent TGT on the movement path PTH at the contact point TPT is a second axis AX2 of the coordinate system CDS. A third axis AX3 of the coordinate system CDS is arranged perpendicular to the first axis AX1 and second axis AX2. With this definition, the orientation of the tool axis TLX in relation to the movement path PTH may be defined as inclined such that a first angle AGI less than 90° forms between a first projection PJ1 of the tool axis TLX in the plane of a planar coordinate system CDS of the second axis AX2 and third axis AX3 in the first quadrant QD1 of the planar coordinate system CDS in relation to the second axis AX2. This one difference of this angle of inclination in relation to 90° may be referred to for illustration as the leading angle of the milling cutter MLN in the direction of the movement path PTH.

Furthermore, the tool axis TLX is inclined in relation to the first axis AX1 such that an angle less than 90° forms between a projection of the tool axis TLX in the plane of a planar coordinate system CDS of the first and third axis AX3 in the first quadrant QD1 of this planar coordinate system CDS in relation to the first axis AX1. This angle deviation MIA, which may also be referred to as the center inclination, of the tool axis from the present third axis AX3 prevents a collision of the milling cutter as a result of the leading angle with the already milled contour. Because these angles depend on the position of the contact point, the resulting movement of the milling cutter is comparable to a tumbling movement in the course of the path movement of the milling cutter. This tumbling only applies for a relative movement of the milling cutter in relation to the workpiece. In a 5-axis machine, the movement path is partially implemented by a rotational and pivot movement of the machine table and partially by the translation of the tool spindle. As a result, there is no tumbling movement in absolute terms, thus for the observer fixed in space.

The path movement expediently extends like a helix along the contour in a depth direction of the contour with removal of the material.

If the contour CNT is a circular pocket that has circular-cylindrical side walls SWL, the movement path PTH is a helix HLX that is circular in cross section. The method results in this case in a thread-like pattern on the side walls SWL. If this scraping milling quality is not desired, the milling cutter MLN may subsequently be aligned and a finishing quality of the side walls SWL may be milled with comparatively little material removal.

In principle, as illustrated in FIG. 2, machining may take place in three method phases MS1, MS2, MS3. In a first method phase MS3, machining takes place with the double tool axis inclination, as already explained.

In a second method phase MS2, the tool axis TLX is aligned in the area of the planar bottom surface GRA to be produced perpendicular to the bottom surface GRA and the side walls SWL are milled by lateral blades CTE of the shaft cutter SFM.

During a third method phase MS3, the planar bottom surface GRA is planar milled by an end face FTS of the shaft cutter SFM.

A production method for producing a circular pocket may include the following instructions by way of example (SPF file or MPF file) to the milling machine having Sinumerik control, e.g., a 5-axis machining here, which define the angles that result in the three-dimensional inclination of the milling cutter. The program or subprogram is by way of example for the Sinumerik control but may also be adopted to any other control. The selected parameters for diameter, depth, angulation, and feed per revolution are transferred in the Sinumerik with the aid of line N10 from the main program to the subprogram.

; HELIX - 5-ACHSBEARBEITUNG
N10 PROC HELIX08 (REAL _DURCH, REAL _TIEF, REAL_SCHRAE,
REAL _STEP) SAVE SBLOF DISPLOF
N20 DEF REAL _APOSX
N30 DEF REAL _APOSY
N40 DEF REAL _APOSZ
N50 DEF REAL _KPOSZ
N60 DEF REAL _KENDZ
N70 DEF REAL _WINK
N80 DEF REAL _VORWI
N90 DEF REAL _CHECK
N100 DEF REAL _ORGDURCH
N110 DEF REAL _MDURCH
N120 _APOSX=$AA_IW[X]
N130 _APOSY=$AA_IW[Y]
N140 _APOSZ=$AA_IW[Z]
N150 _KPOSZ=_APOSZ
N160 _WINK=0
N170 _VORWI=_SCHRAE
N180 _ORGDURCH=_DURCH
N190 _MDURCH=0
;FALL multiple passes necessary start
N200 CYCLE832 (0.05,_ROUGH,1)
N210 WIED2:
N220 _MDURCH=_MDURCH+1
N230 IF (_MDURCH*$P_TOOLR*2)<(_ORGDURCH−2*$P_TOOLR)
N240 _DURCH=(_MDURCH+1)*($P_TOOLR*2)
N250 ELSE
N260 _DURCH=_ORGDURCH
N270 ENDIF
N280 STOPRE
;FALL multiple passes necessary end
;check - are the parameters reasonable (WKZ DM?, too deep?, necessary SCHRAEGE? -
START
N290 IF_SCHRAE<=(ATAN2(_STEP,(0.75*2*3.14*(_DURCH/2− $P_TOOLR))));if
angles of inclination too low
N300 _SCHRAE=ATAN2(_STEP,(0.75*2*3.14*(_DURCH/2−
$P_TOOLR)));set angles of inclination
N310 ENDIF
N320 _VORWI=_SCHRAE
N330 _CHECK=(_DURCH−
($P_TOOLR*2))/(SQRT((sin(_SCHRAE)*sin(_SCHRAE))*2))
N340 IF _CHECK<=_TIEF
N350 MSG (“too deep for the required angulation”)
N360 M0
N370 M30
N380 ENDIF
;check - are the parameters reasonable (WKZ DM?, too deep?, necessary SCHRAEGE? -
ENDE
;Approach starting position start
N390 TRAORI
N400 OTOL=0.1
N410 ORISON
N420 FGREF[C]=(_DURCH);rotational velocity degrees per unit of time convert into
path for unit of time
N430 _DURCH=_DURCH/2−$P_TOOLR;helix diameter center point path - from now
radius!!!!
N440 _KPOSZ=_KPOSZ+sin (_SCHRAE)*$P_TOOLR;height correction by angulation
N450 _KENDZ=_APOSZ+(−
1)*_TIEF+sin(_SCHRAE)*$P_TOOLR;depth correction by angulation
N460 G1 X=_APOSX+COS(0)*_DURCH
Y=_APOSY+SIN(0)*_DURCH/approach starting position
N470 G1 Z=_KPOSZ A3=(COS(_WINK+180−
_VORWI)*TAN(_SCHRAE))B3=(SIN(_WINK+180−_VORWI)*TAN(_SCHRAE)
C3=(cos(_SCHRAE))
;corrected height by angulation approach with angulation end
;loop helix path start
N490 STOPRE
N500 MARK1:
N510 _WINK=_WINK+(360/(6.28*_DURCH*2))
N520 _KPOSZ=_KPOSZ−(_STEP/(360/(360/(6.28*_DURCH*2))))
N530 IF_KPOSZ<_KENDZ
N540 _KPOSZ=_KENDZ
N550 ENDIF
N560 G1 X=_APOSX+COS(_WINK)*_DURCH
Y=_APOSY+SIN(_WINK)*_DURCHZ=_KPOSZ
A3=(SIN(_WINK+180+45+_VORWI)*tan(_SCHRAE))
B3=(SIN(_WINK+90+45+_VORWI)*TAN(_SCHRAE))
C3=(cos(_SCHRAE))
N570 IF(_WINK+(360/(6.28*_DURCH*2)))<360
N580 GOTOB MARK1
N590 ENDIF
N600 IF _KPOSZ>(_KENDZ)
N610 _WINK=0
N620 GOTOB MARK1
N630 ENDIF
;loop helix path end
;loop to the end depth with reduced angulation
- start
N640 _DURCH=((DURCH/2)*(cos(SCHRAE))*cos(SCHRAE))*2
N650 _WINK=0
N660 SPRUNG:
N670 _WINK=_WINK+(360/(6.28*_DURCH*2))
N680 G1 X=_APOSX+COS(_WINK)*_DURCH
Y=_APOSY+SIN(_WINK)*_DURCH
Z=_KENDZ+((sin(_WINK/4))*(sin(_SCHRAE)*$P_TOOLR))
A3=(cos(_WINK/4))*(COS(_WINK+180−_VORWI)*tan(_SCHRAE))
B3=(cos(_WINK/4))*(SIN(_WINK+180−_VORWI)*TAN(_SCHRAE))
C3=(cos(_SCHRAE))
N690 IF (_WINK)<=360
N700 GOTOB SPRUNG
N710 ENDIF
;loop to the end depth with reduced angulation
- end
;loop to the end depth without angulation - start
N720 _WINK=0
N730 SPRUNG:
N740 _WINK=_WINK+(360/(6.28*_DURCH*2))
N750 G1 X=_APOSX+COS(_WINK)*_DURCH
Y=_APOSY+SIN(_WINK)*_DURCH Z=_KENDZ−(sin(_SCHRAE)*$P_TOOLR)
A3=0 B3=0 C3=1
N760 IF (_WINK)<=360
N770 GOTOB SPRUNG
N780 ENDIF
;loop to the end depth - end
;approach starting position again - start
N790 G1 Z=_APOSZ
N800 G1 X=_APOSX Y=_APOSY A3=0 B3=0 C3=1
;approach starting position again - END
;CASE multiple passes
N810 IF (_MDURCH*$P_TOOLR*2)<(_ORGDURCH−2*$P_TOOLR)/again org.
Durch then possible jump back
N820 _KPOSZ=_APOSZ
N830 _WINK=0
N840 GOTOB WIED2
N850 ENDIF
N860 TRAFOOF
;N870 FGREF[C]=10
N880 M17

1. A method for chipping production of a concave contour in a workpiece by a milling cutter of a milling machine, the method comprising:
guiding the milling cutter during a machining operation along a movement path such that one or more blades of the milling cutter remove material of the workpiece, so that the concave contour results, wherein the milling cutter is rotatable around a tool axis, and wherein the movement path comprises curved sections; and
permanently adjusting an inclination of the tool axis of the milling cutter in relation to the movement path during movement along the curved sections of the movement path such that the milling cutter only removes material from the workpiece using first blades of the one or more blades located in front in a present movement direction along the movement path and second blades of the one or more blades respectively located at a rear in the present movement direction along the movement path do not perform material removal from the workpiece.

2. (canceled)

3. The method of claim 1, wherein the first blades of the one or more blades are located in an angle range up to 90° in absolute value in each case in relation to the present movement direction along the movement path in a peripheral direction of the milling cutter with respect to the tool axis, and
wherein the second blades of the one or more blades enclose an angle of greater than 90° in absolute value with the present movement direction along the movement path.

4. The method of claim 1, wherein a present contact point of the milling cutter on the material of the concave contour to be produced defines a zero point of a three-dimensional coordinate system,
wherein a surface normal of the concave contour to be produced at the present contact point of the milling cutter on the material defines a first axis of the three-dimensional coordinate system,
wherein a tangent on the movement path at the present contact point defines a second axis of the three-dimensional coordinate system and a third axis of the three-dimensional coordinate system is arranged perpendicular to the first axis and second axis,
wherein the tool axis is inclined in relation to the movement path such that a first angle less than 90° forms between a first projection of the tool axis in a plane of the three-dimensional coordinate system of the second axis and the third axis in a first quadrant (QD1) of the three-dimensional coordinate system in relation to the second axis, and
wherein the tool axis is inclined in relation to the first axis such that an angle less than 90° forms between a projection of the tool axis in a plane of the three-dimensional coordinate system of the first axis and the third axis in the first quadrant of the three-dimensional coordinate system in relation to the first axis.

5. The method of claim 1, wherein the concave contour has circular-cylindrical side walls, and
wherein the movement path is a helix.

6. The method of claim 1, wherein the concave contour comprises a planar bottom surface and side walls perpendicular to the planar bottom surface,
wherein the milling cutter is a cylindrical shaft cutter,
wherein the method further comprises:
aligning the tool axis in an area of the planar bottom surface to be produced perpendicular to the planar bottom surface;
milling of the side walls by lateral blades of the cylindrical shaft cutter; and
planar milling the planar bottom surface by an end face of the shaft cutter.

7. The method of claim 1, wherein the milling machine is a 5-axis milling machine.

8. The method of claim 7, wherein three translational movement axes of a tool holder, a pivot axis of a machine table, and a rotational axis of the machine table are provided.

9. A milling machine comprising:
a milling cutter configured to be guided during a machining operation along a movement path such that one or more blades of the milling cutter remove material of a workpiece to produce a concave contour,
wherein the milling cutter is rotatable around a tool axis,
wherein the movement path comprises curved sections, and
wherein an inclination of the tool axis of the milling cutter is configured to be permanently adjusted in relation to the movement path during movement along the curved sections of the movement path such that the milling cutter only removes material from the workpiece using first blades of the one or more blades located in front in a present movement direction along the movement path and second blades of the one or more blades respectively located at a rear in the present movement direction along the movement path are not configured to perform material removal from the workpiece.

10. The milling machine of claim 9, wherein the milling machine is a 5-axis milling machine.

11. The milling machine of claim 10, wherein the 5-axis milling machine comprises:
a tool holder having three translational movement axes; and
a machine table having a pivot axis and a rotational axis.

12. The milling machine of claim 9, wherein the concave contour is a pocket or a circular pocket.

13. The method of claim 1, wherein the concave contour is a pocket or a circular pocket.
